(19) United States
(12) Patent Application Publication
(10) Pub. No.: US 2018/0372860 A1
(43) Pub. Date: Dec. 27, 2018

(54) OBJECT DETECTION DEVICE AND OBJECT DETECTION METHOD

(71) Applicant: DENSO CORPORATION, Kariya-city, Aichi-pref. (JP)

(72) Inventor: Takahiro BABA, Kariya-city, Aichi-pref. (JP)

(21) Appl. No.: 16/062,567

(22) PCT Filed: Nov. 30, 2016
(86) PCT No.: PCT/JP2016/085518

§ 371 Date: Jun. 14, 2018

(30) Foreign Application Priority Data
Dec. 17, 2015 (JP) 2015-246687

(51) Int. Cl. G01S 13/86; G01S 13/93

(52) U.S. Cl. CPC G01S 13/867; G01S 13/931

(57) ABSTRACT

In an object detection device, an object inside a first detection range is detected as a first target. An object inside the first detection range and a second detection range, which is narrower in a vehicle width direction than the first detection range, is detected as a second target. As a target object, the object is selected when the first target and second target are the same object, in a first state where a detection position of the object is inside the first and second detection ranges. It is determined whether a detection position of the target object has transitioned from the first state to a second state where the detection position of the object is outside the second detection range and inside the first detection range. Selection for the target object is continued if the target object is a predetermined moving object, when it is determined that the detection position of the target object has transitioned to the second state.

### CROSS-REFERENCE TO RELATED APPLICATIONS

This application is based on Japanese Patent Application No. 2015-246687 filed on Dec. 17, 2015, the contents of which are incorporated herein by reference.

### BACKGROUND

### Technical Field

The present disclosure relates to an object detection device and an object detection method for detecting an object present around the own vehicle.

### Background Art

According to a technique described in PTL 1, in order to increase accuracy in detection of an object present around the own vehicle, the object is detected individually by using a radar and a camera. An object present around the own vehicle is detected on the condition that a positional relationship between an object detected by the radar and an object detected by the camera satisfies a predetermined determination criterion and it is determined that the object detected by the radar and the object detected by the camera are the same object.

During the detection, when an object detection range of the radar does not agree with an object detection range of the camera, the object may be outside one of the detection ranges. In such a case, the reliability the result of detection of the object decreases, and thus control such as collision avoidance with respect to the object needs to be limited.

### CITATION LIST

### Patent Literature

### PTL 1: JP 2008-186170 A

Depending on a type of the object, if accuracy in detection of the object decreases, the object may approach the own vehicle, and thus collision avoidance control may be necessary.

### SUMMARY

A main object of the present disclosure is to provide an object detection device and an object detection method which are capable of appropriately performing collision avoidance control with respect to an object detected by using a plurality of detection sections having different detection ranges.

A first aspect of the present disclosure includes: a first target detection section for detecting, as a first target, an object included in a first detection range ahead of the own vehicle; a second target detection section for detecting, as a second target, an object included in the first detection range and in a second detection range laterally narrower than the first detection range; a selection section for selecting, as a target object to be subjected to collision avoidance control, the object on the condition that the first target and the second target are the same object, in a first state where a detection position of the object is inside the first detection range and inside the second detection range; a state determination section for determining whether a detection position of the target object has transitioned from the first state to a second state where the detection position of the object is outside the second detection range and inside the first detection range; a moving object determination section for determining whether the target object is a predetermined moving object; and a continuation determination section for continuing selection as the target object on the condition that the target object is the predetermined moving object, when the detection position of the target object has transitioned to the second state.

According to the present disclosure, when the second detection range of the second target detection section is narrower in the vehicle width direction than the first detection range of the first target detection section, the detection position of the target object may transition from the first state where the detection position of the target object is inside the first detection range and inside the second detection range to the second state where the detection position of the target object is outside the second detection range and inside the first detection range. When the detection position of the target object has transitioned to the second state, reliability of a result of detection of the target object decreases, and thus collision avoidance control with respect to the target object needs to be limited.

Depending on a type of the target object; however, limitation of collision avoidance control with respect to the target object may cause a problem. Thus, when the detection position of the target object has transitioned to the second state, the state of the object being selected as a target object is maintained on the condition that the target object is the predetermined moving object. In other words, when the detection position of the target object has transitioned to the second state, the state where the object is selected as the target object is not cancelled and is maintained on the condition that the target object is the predetermined moving object. Accordingly, if the reliability in the detection position of the object decreases, collision avoidance control will be appropriately performed with respect to the predetermined moving object that has been once determined as a target object.

### BRIEF DESCRIPTION OF THE DRAWINGS

The object described above and other objects, features, and advantageous effects of the present disclosure are clarified by the detailed description below with reference to the accompanying drawings. In the accompanying drawings:

FIG. 1 is a block diagram illustrating a schematic configuration (FIG. 1 (a)) and a functional configuration (FIG. 1 (b)) of a hardware of an object detection device according to the present embodiment.

FIG. 2 is a diagram illustrating a detection ranges of a radar and an image sensor.

FIG. 3 is a flow chart of a target object determination process performed by the object detection device according to the present embodiment.

FIG. 4 is a flow chart of a collision avoidance process.

FIG. 5 shows in (a) and (b) diagrams each illustrating an orientation of a two-wheeled vehicle that is identified by image processing.

FIG. 6 is a flow chart illustrating a modification of a continuation determination process.

### DESCRIPTION OF THE EMBODIMENTS

Some embodiments will be described hereinafter with reference to the drawings. The components identical with or similar to those in the embodiments described below are given the same reference signs for the sake of omitting unnecessary explanation.

An object detection device 10 according to the present embodiment is mounted in the own vehicle and detects an object present around the own vehicle.

Information on the object detected by the object detection device 10 is used for various types of vehicle control such as avoidance of a collision with the own vehicle. For example, the information is used for various types of vehicle collision avoidance control such as a pre-crash safety system (PCS).

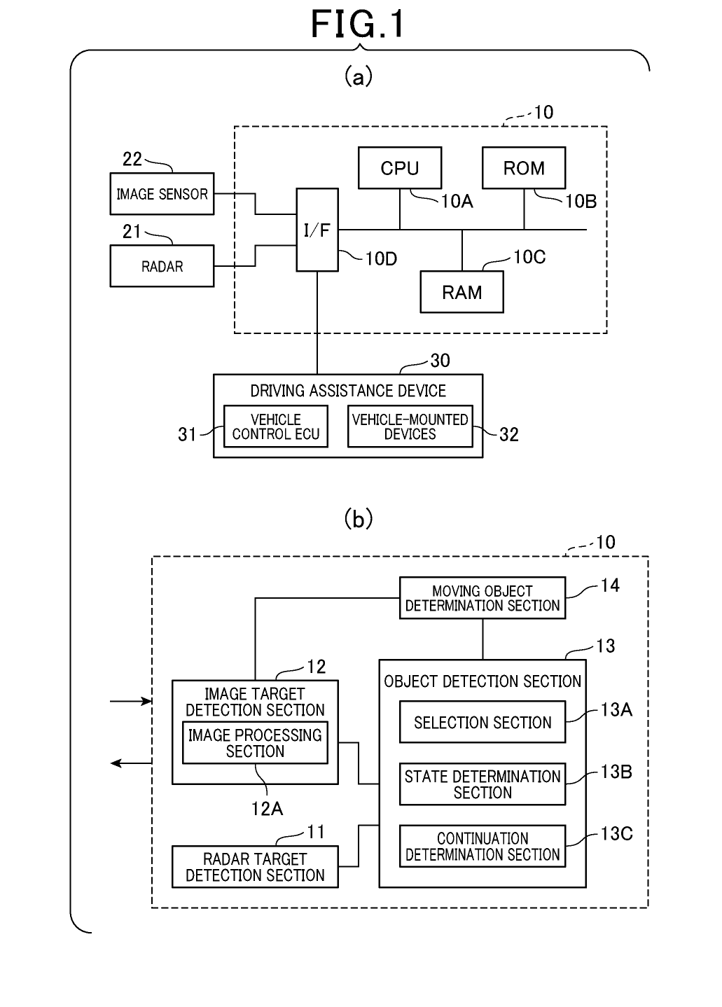

In FIG. 1 (a), the object detection device 10 is connected to a radar 21, an image sensor 22, and a driving assistance device 30 to enable communication therebetween.

The radar 21 transmits and receives a directional electromagnetic waves such as millimeter waves or a laser. The radar 21 then outputs transmitted/received data to the object detection device 10 as a radar signal, the data including the distance to the object that has reflected the electromagnetic waves, the azimuth of the object, and the speed of the object relative to the own vehicle, and the like.

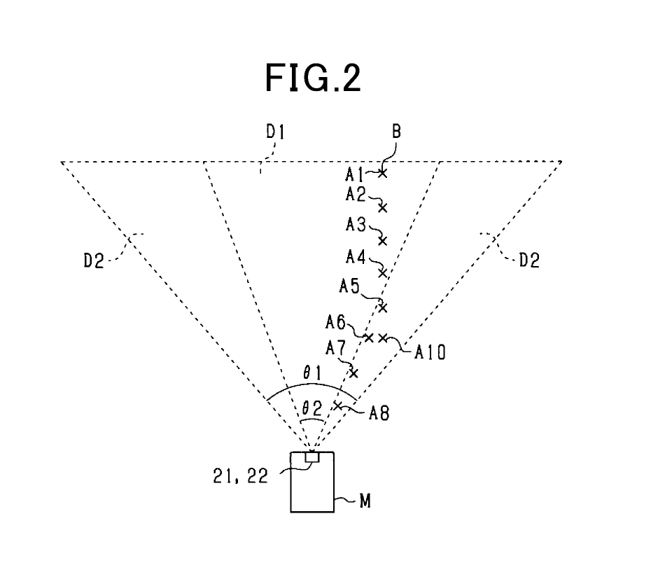

For example, as shown in FIG. 2, the radar 21 is provided at a front end of the own vehicle M and detects, as a radar signal, reflected waves from an object included in a predetermined detection range (corresponding to a first detection range) 01.

The image sensor 22 includes an imaging element such as a charged-coupled device (CCD) or a complementary metal-oxide semiconductor (CMOS) and captures an image of an area around the own vehicle M at a predetermined angle of view. Then the image sensor 22 outputs an image captured by the image sensor 22 to the object detection device 10 as an image signal.

For example, as shown in FIG. 2, the image sensor 22 is provided near the center on a front side of the own vehicle M and detects, as an image signal, a captured image in a predetermined detection range (corresponding to a second detection range) θ2. The detection range θ2 has an angle range narrower than the detection range θ1 of the radar 21, and the whole detection range θ2 is included in the detection range θ1. In FIG. 2, a lateral width (width in a vehicle width direction) of each of the detection ranges θ1 and θ2 is determined such that the lateral width increases in a direction of distancing from the own vehicle M, and decreases in a direction of nearing the own vehicle M.

As shown in FIG. 1 (a), the object detection device 10 includes a central processing unit (CPU) 10A, a read only memory (ROM) 10B, a random access memory (RAM) 10C, an input-output interface (I/F) 10D, and the like. The object detection device 10 is mainly configured by a well-known microcomputer, and various processes are performed by the CPU 10A based on a program stored in the ROM 10B. The ROM 10B corresponds to a recording medium, which functions as a non-transitory computer readable recording medium. Besides the ROM 10B, the recording medium includes, for example, computer readable electronic media such as a digital versatile disk read only memory (DVD-ROM), a compact disc read only memory (CD-ROM), and a hard disk. The object detection device 10 receives a radar signal from the radar 21 and an image signal from the image sensor 22 at predetermined time intervals. The object detection device 10 then uses the received radar signal and image signal to perform various functions by a radar target detection section 11, an image target detection section 12, an object detection section 13, and a moving object determination section 14 shown in FIG. 1 (b).

The radar target detection section 11 generates a radar target (corresponding to a first target) by using position information of a target specified based on the radar signal outputted from the radar 21. The radar target detection section 11 then outputs the radar target to the object detection section 13.

The image target detection section 12 recognizes, as an image target (corresponding to a second target), an object detected by analyzing the captured image indicated by the image signal outputted from the image sensor 22. The image target detection section 12 includes an image processing section 12A for identifying a type of the object by image processing of a captured image of an area ahead of the own vehicle M. The image target detection section 12 recognizes the image target, for example, by a matching process using a target model registered in advance. The target model is prepared for each type of image target, so that the type of the image target is identified. Examples of the type of image target include a moving object such as a four-wheeled vehicle, a two-wheeled vehicle, or a pedestrian and a stationary object such as a guardrail. Note that the two-wheeled vehicle here includes a bicycle, a saddle riding type motorcycle, and the like. The image target detection section 12 then outputs, to the object detection section 13, information such as the extracted type of the image target, the distance between the own vehicle M and the image target, the azimuth of the image target with respect to the own vehicle M, the relative speed between the own vehicle M and the image target, and lateral width of the image target.

The object detection section 13 determines whether the radar target outputted from the radar target detection section 11 and the image target outputted from the image target detection section 12 have been generated from the same object. For example, the object detection section 13 sets a predetermined image search range in the captured image by using position information of the target identified as the radar target. The image search range is set as a range for which an error in a detection position of the image target is taken into account. When the image target is included in the image search range, the object detection section 13 determines that the radar target and the image target have been generated from the same object. When the object detection section 13 determines that the radar target and the image target have been generated from the same object, a selection section 13A of the object detection section 13 selects the object as a control target object (target object) to be subjected to collision avoidance control. The selection section 13A then transmits information on the target object to the driving assistance device 30.

The driving assistance device 30 includes a vehicle control electronic control unit (ECU) 31 for performing collision avoidance control and vehicle-mounted devices 32 such as a loudspeaker outputting an alarm sound and a guide sound, a seat belt tightening device, a brake device, and a steering device. The vehicle control ECU 31 determines whether driving assistance is necessary with respect to the target object detected by the object detection section 13. When the vehicle control ECU 31 determines that driving assistance is necessary, the vehicle control ECU 31 activates each of the vehicle-mounted devices 32.

For example, the vehicle control ECU 31 calculates time to collision (TTC) between the target object and the own vehicle M. The time to collision (TTC) is an evaluation value indicating the remaining number of seconds before the own vehicle collides with the target object when the own vehicle continues to travel at the current speed. As the time to collision (TTC) is decreased, the own vehicle is more likely to collide with the target object, and as the time to collision (TTC) is increased, the own vehicle is less likely to collide with the target object. The time to collision (TTC) can be calculated, for example, by dividing a distance between the target object and the own vehicle M in a direction of travel by a relative speed to the target object. The relative speed to the target object is obtained by subtracting a vehicle speed of the own vehicle from a vehicle speed of a preceding vehicle. The time to collision (TTC) can also be calculated by taking into account relative acceleration.

When the time to collision (TTC) is equal to or less than an activation time of each of the vehicle-mounted devices 32, the vehicle control ECU 31 activates the corresponding one of the vehicle-mounted devices 32. The activation time of each of the vehicle-mounted devices 32 is set according to a type of the object.

When the detection range (first detection range) 01 of the radar target does not agree with the detection range (second detection range) θ2 of the image target, a detection position of the object may transition from the state (corresponding to a first state) where the detection position of the object is included in both (overlapping part) of the detection range θ1 of the radar target and the detection range θ2 of the image target to the state (corresponding to a second state) where the detection position of the object is included in only one of the detection ranges θ1 and θ2.

For example, in FIG. 2, the lateral width (width in the vehicle width direction) of each of the detection ranges θ1 and θ2 is determined such that the lateral width increases in a direction distancing from the own vehicle M, and decreases in a direction of nearing the own vehicle M. In this case, when the object is located at a position farther from the own vehicle M, the detection position of the object is included in a region D1 which is the overlapping part of the detection range θ1 and the detection range θ2. As the object approaches the own vehicle M, the detection position of the object may transition to the state where the detection position of the object is included in a region D2 which is outside the detection range θ2 and inside the detection range θ1. A state determination section 13B of the object detection section 13 determines whether the detection position of the object has transitioned to such a state.

More specifically, in FIG. 2, assume that a detection position of an object B present ahead of the own vehicle M has been detected at positions A1 to A8 in this order from a distant position to a closer position. During the detection, when the object B is detected at the positions A1 to A4 in the region D1, the object is detected by both of the radar 21 and the image sensor 22. Accordingly, the selection section 13A of the object detection section 13 determines that the radar target and the image target are the same object, and thus the object is selected as the target object.

When the object B is detected at the position A5 in the region D2, the object is detected only by the radar 21, and thus the object is not selected as the target object by the selection section 13A of the object detection section 13.

Depending on a type of the object B; however, even when accuracy in detection of the object decreases, the object may approach the own vehicle M, and thus collision avoidance control with respect to the object (moving object) may be necessary. That is, when the type of the object is a two-wheeled vehicle, the two-wheeled vehicle may cross an own vehicle lane at high movement speed (lateral speed). Accordingly, when the object is a two-wheeled vehicle, it is preferred that the object B is continuously selected as the target object even in a situation where the object B is detected only by the radar 21.

Thus, the moving object determination section 14 determines whether the target object is a two-wheeled vehicle. The moving object determination section 14 can determine that whether the target object is a two-wheeled vehicle based on a signal provided from the image processing section 12A of the image target detection section 12. If the type of the target object is a two-wheeled vehicle, a continuation determination section 13C of the object detection section 13 continues to select the two-wheeled vehicle as the target object, even when the target object is detected only by the radar 21.

During the determination, even when the type of the target object is a two-wheeled vehicle, when the two-wheeled vehicle is standing still (when the movement speed is zero), the two-wheeled vehicle is less likely to approach the own vehicle M. Furthermore, even when the two-wheeled vehicle is moving at a predetermined speed, when the two-wheeled vehicle is moving away from the own vehicle M in a direction orthogonal to the direction of travel of the own vehicle M, the two-wheeled vehicle and the own vehicle M are less likely to collide with each other.

Thus, when the target object is a two-wheeled vehicle, the continuation determination section 13C of the object detection section 13 of the present embodiment continues to select the two-wheeled vehicle as the target object on the condition that the movement speed (lateral speed) of the two-wheeled vehicle in the direction orthogonal to the direction of travel of the own vehicle M is higher than a predetermined value and that the two-wheeled vehicle is moving closer to the own vehicle M. The movement speed of the two-wheeled vehicle is obtained based on a relative speed to the own vehicle M. A direction in which the two-wheeled vehicle is moving is obtained, for example, based on a vector component in a lateral direction obtained by resolving the movement speed of the two-wheeled vehicle into a vector component in a longitudinal direction and the vector component in the lateral direction.

Furthermore, as more time has elapsed after the transition to the state where the object selected as the control target object is detected in the region D2, that is, the state where the object is detected only by the radar 21, reliability of a result of detection of the object decreases. As the reliability decreases, unnecessary activation with respect to the object is more likely to be performed. Thus, the continuation determination section 13C of the object detection section 13 of the present embodiment continues to select the object selected as the control target object as the target object on the condition that time that has elapsed after the transition to the state where the target object is detected only by the radar 21 is short.

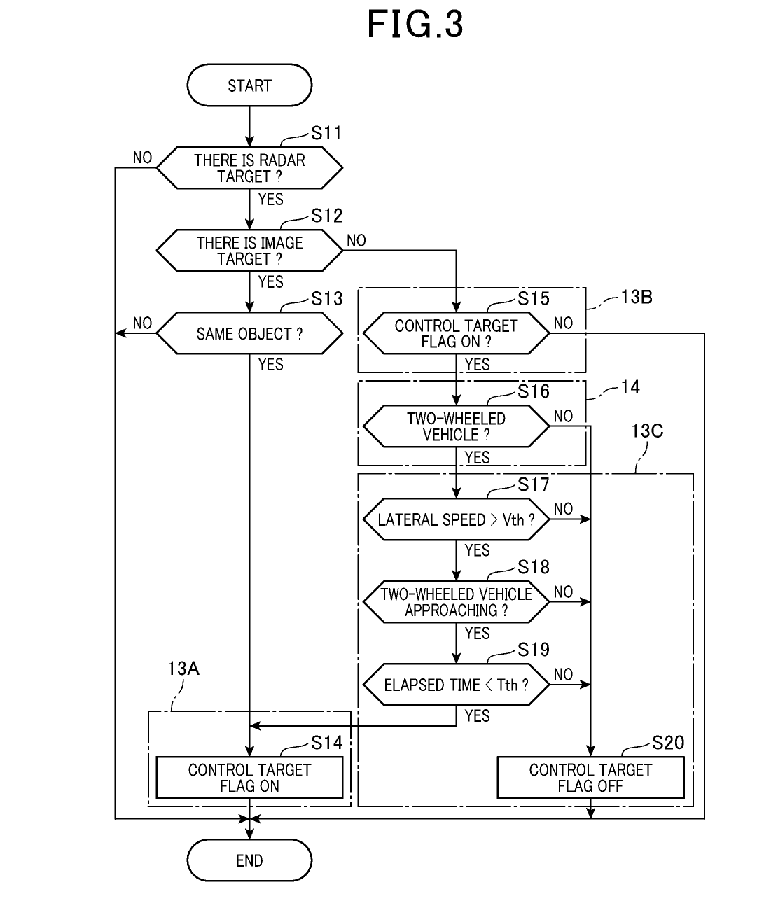

With reference to a flow chart shown FIG. 3, the following description discusses a process performed by the object detection device 10 of the present embodiment. The process below is cyclically by the object detection device 10.

First, it is determined whether there is a radar target (S11). When a negative determination is made in S11, the process terminates. When it is determined in S11 that there is a radar target, it is determined whether there is an image target (S12). When there is an image target, it is determined whether the radar target detected in S11 and the image target detected in S12 are the same object (S13). When it is determined in S13 that the radar target and the image target are not the same object, the process terminates. When it is determined in S13 that the radar target and the image target are the same object, a control target flag is turned ON (S14). When the control target flag is ON, the object is selected as a target object for the driving assistance device 30, and it becomes possible to control such as collision avoidance with respect to the object. Specifically, information indicating that the control target flag is ON is outputted from the object detection device 10 to the driving assistance device 30. Then, based on time to collision (TTC) at each time, the driving assistance device 30 performs collision avoidance control by at least one of an alarm, brake control, steering control, and the like.

When a negative determination is made in S12, it is determined whether the control target flag is ON (S15). Specifically, in S15, the state determination section 13B determines whether a detection position of the object has transited from the state where the detection position of the object is included in both of the detection range θ1 of the radar target and the detection range θ2 of the image target to the state where the detection position of the object is outside the detection range θ2 of the image target and inside the detection range θ1 of the radar target. When an affirmative determination is made in S15, it is determined whether a type of the object is a two-wheeled vehicle (S16). Determination in this process is made based on a type of the image target identified by the matching process using the target model. When it is determined in S16 that the type of the object is a two-wheeled vehicle (YES in S16), it is determined whether a lateral speed of the object is higher than a predetermined value Vth (S17).

When the lateral speed of the object is higher than the predetermined value Vth (YES in S17), it is determined whether the object is in an approaching state where the object is approaching the own vehicle M (S18). When an affirmative determination is made in S18, it is determined whether time that has elapsed after the transition to the state where only the radar target is detected for the target object is less than a predetermined value Tth (S19).

When an affirmative determination is made in S19, control proceeds to S14. In this case, the state where the control target flag is ON is continued, and thus driving assistance with respect to the object can be provided even in a situation where only the radar target is detected (situation where no image target is detected) for the target object. When a negative determination is made in S16 to S19, the control target flag is turned OFF (S20).

With reference to FIG. 2, an example of execution of the process set forth above will be described. In FIG. 2, the object B is a two-wheeled vehicle.

(a) Case where Two-Wheeled Vehicle is Moving Closer to Own Vehicle M at Lateral Speed Higher than Predetermined Value Vth

In FIG. 2, when the two-wheeled vehicle is detected at the positions A1 to A4 in the region D1, the two-wheeled vehicle is detected as both of the radar target and the image target, and thus the two-wheeled vehicle is selected as the target object. Then, when the two-wheeled vehicle is detected at the position A5 in the region D2, the two-wheeled vehicle is detected only as the radar target. During the detection, the two-wheeled vehicle is moving closer to the own vehicle M at the lateral speed higher than the predetermined value Vth. Furthermore, time that has elapsed after the transition to the state where the two-wheeled vehicle is detected only as the radar target is less than the predetermined value Tth. In this case, even when the two-wheeled vehicle is detected at the position A5 in the region D2, the two-wheeled vehicle is continuously selected as the target object. Then, as the two-wheeled vehicle laterally moves, the two-wheeled vehicle gradually approaches the own vehicle M and the two-wheeled vehicle is detected at the positions A6 to A8 in the region D2. In this case, when time to collision (TTC) of the two-wheeled vehicle reaches the activation time of each of the vehicle-mounted devices, the corresponding one of the vehicle-mounted devices 32 is activated by the vehicle control ECU 31 of the driving assistance device 30.

(b) Case where Two-Wheeled Vehicle is Standing Still

In FIG. 2, when the two-wheeled vehicle is detected at the positions A1 to A4 in the region D1, both of the radar target and the image target are detected, and thus the two-wheeled vehicle is selected as the target object. Then, when the two-wheeled vehicle is detected at a position A10 in the region D2, the two-wheeled vehicle is detected only as the radar target. In this case, the two-wheeled vehicle is standing still (the lateral speed of the two-wheeled vehicle is zero), and thus the selection of the two-wheeled vehicle as the target object is cancelled. Accordingly, unwanted activation of the vehicle-mounted devices with respect to the two-wheeled vehicle can be avoided when the two-wheeled vehicle is less likely to approach the own vehicle M.

The above configuration provides the following advantageous effects.

When the detection range θ2 of the image sensor 22 is narrower in the vehicle width direction than the detection range θ1 of the radar 21, the detection position of the target object may transitioned from the first state where the detection position of the target object is inside the detection range θ1 and inside the detection range θ2 to the second state where the detection position of the target object is outside the detection range θ2 and inside the detection range θ1. When the detection position of the target object has transitioned to the second state, the reliability of the result of detection of the target object decreases, and thus the collision avoidance control with respect to the target object needs to be limited.

When the type of the target object is a two-wheeled vehicle; however, limitation of collision avoidance control with respect to the two-wheeled vehicle may cause a problem. Thus, when the detection position of the target object has transitioned to the second state, the object detection section 13 continues to select the two-wheeled vehicle as the target object on the condition that the target object is a two-wheeled vehicle. Accordingly, if the reliability of the detection position of the object decreases, collision avoidance control with respect to the two-wheeled vehicle will be appropriately performed, if the reliability of the detection position of the object decreases.

When the movement speed of the target object in the direction orthogonal to the direction of travel of the own vehicle M is higher than the predetermined value and the target object is moving closer to the own vehicle M, the selection as the target object is continued. Accordingly, if the reliability of the detection position of the target object decreases, collision avoidance control will be appropriately performed with respect to the target object when the target object and the own vehicle M are likely to collide with each other with high probability.

When the target object is moving away from the own vehicle M in the lateral direction orthogonal to the direction of travel of the own vehicle M, the own vehicle M and the target object are less likely to collide with each other. In such a case, therefore, the selection as the target object is cancelled. Accordingly, unwanted activation of the vehicle-mounted devices can be avoided when the reliability of the detection position of the target object decreases, and when the own vehicle M and the target object are less likely to collide with each other.

The selection as the target object is continued on the condition that time that has elapsed after the target object has transitioned to the second state is less than the predetermined value. In this case, unwanted activation of the vehicle-mounted devices can be avoided with respect to the object due to the duration of decreasing in reliability of the object.

The aforementioned embodiment may be altered, for example, as below. In the following description, components similar to the aforementioned components are given the same reference signs of the drawings and detailed descriptions on such components are omitted. The aforementioned embodiment and embodiments described below can be implemented in combination.

According to the aforementioned embodiment, when the control target flag is turned ON by the object detection device 10, the flag information is outputted from the object detection device 10 to the driving assistance device 30, and the driving assistance device 30 performs collision avoidance control. However, the configuration can be altered such that when the control target flag is turned ON, the object detection device 10 determines whether to perform collision avoidance control.

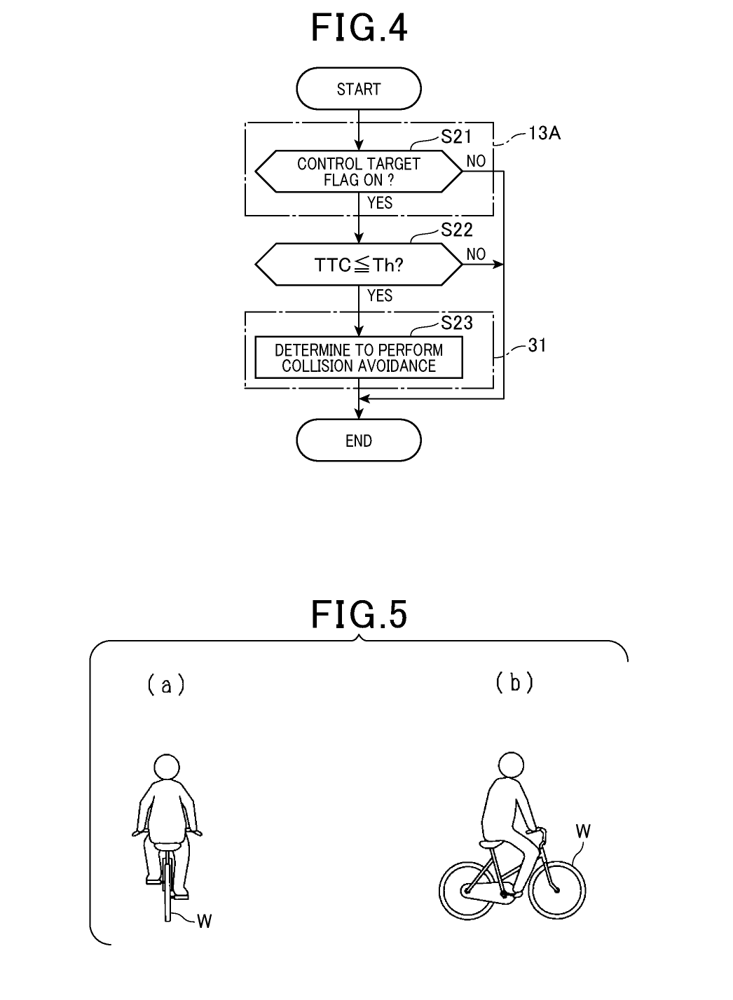

For example, the object detection device 10 performs a collision avoidance process shown in FIG. 4. According to FIG. 4, it is determined whether the control target flag is ON (S21). When an affirmative determination is made in S21, it is determined whether time to collision (TTC) is equal to or less than an activation time Th of the vehicle-mounted device (S22). When an affirmative determination is made in S22, it is determined to perform collision avoidance control such as issuance of an alarm, application of the brake, or steering in a direction at which no object is present (S23). That is, in the process shown in FIG. 4, when the selection as the target object is continued and the target object is likely to collide with the own vehicle with high probability, it is determined to perform collision avoidance control. In this case, a command to perform collision avoidance control is outputted from the object detection device 10 to the driving assistance device 30, and then the driving assistance device 30 performs collision avoidance control.

In the flow chart shown in FIG. 3, the order of the processes in S16 to S19 can be changed. Furthermore, any of the processes in S17 to S19 can be omitted. For example, all of the processes in S17 to S19 can be omitted. In this case, in the flow chart shown in FIG. 3, when it is determined in S15 that the control target flag is ON, it is determined in S16 whether the object is a two-wheeled vehicle. Then, on the condition that a two-wheeled vehicle is determined as the object, control proceeds to S14 and the control target flag can continuously be in ON-state. In this case, the selection as the target object is continued only on the condition that the object is a two-wheeled vehicle.

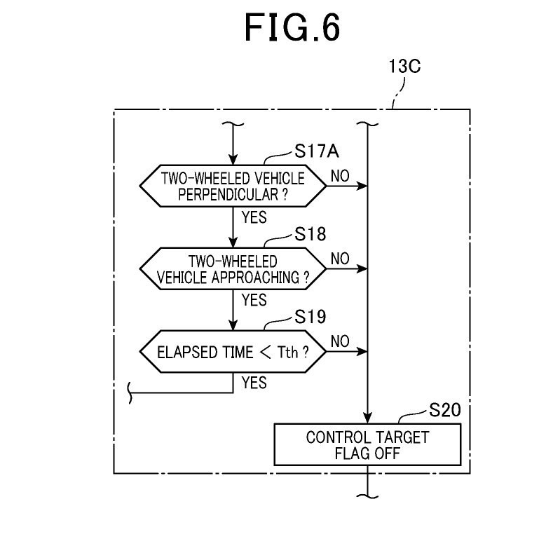

In this regard, when the two-wheeled vehicle is traveling ahead of the own vehicle M with wheels W being juxtaposed longitudinal to the own vehicle M as shown in FIG. 5 (a), or when the two-wheeled vehicle is traveling ahead of the own vehicle M with the wheels W being juxtaposed perpendicular to the own vehicle as shown in FIG. 5 (b). When the two-wheeled vehicle is longitudinal to the own vehicle M, the two-wheeled vehicle is relatively less likely to cross the own vehicle lane. However, when the two-wheeled vehicle is perpendicular to the own vehicle M, that is, when a direction of travel of the two-wheeled vehicle is oriented to the own vehicle lane, the two-wheeled vehicle is relatively likely to cross the own vehicle lane with high probability. Thus, in the flow chart shown in FIG. 3, instead of the process for determining the lateral speed in S17, the continuation determination section 13C of the object detection section 13 determines whether the two-wheeled vehicle is perpendicular to the own vehicle M (S17A) as shown in FIG. 6. Then, on the condition that it is determined that the two-wheeled vehicle is perpendicular to the own vehicle M, the selection as the target object can be continued.

As described above, in the case where the selection as the target object is continued on the condition that the two-wheeled vehicle as the target object is located ahead of the own vehicle M and that the direction of travel of the two-wheeled vehicle is oriented to the own vehicle lane, regardless of the movement speed of the two-wheeled vehicle, the selection as the object which is the control target object is continued when the two-wheeled vehicle is likely to approach the own vehicle M with high probability. That is, if the two-wheeled vehicle is standing still, the selection as the target object is continued when the two-wheeled vehicle is perpendicular to the own vehicle M while having a high probability of approaching the own vehicle M (the two-wheeled vehicle crosses the own vehicle lane with high probability).

In this regard, a pedestrian may also cross the own vehicle lane and approach the own vehicle M. Thus, also when the moving object determination section 14 determines that the type of the object is a pedestrian, the selection as the target object can be continued. When the target object is a pedestrian and a lateral speed of the pedestrian is low, a collision risk with the own vehicle M is low. Thus, it is preferred that the continuation determination section 13C of the object detection section 13 continues to select the pedestrian as the target object on the condition that the lateral speed of the pedestrian is higher than a predetermined value.

In the flow chart shown in FIG. 3, according to the reliability of the detection in which the target object is detected as both of the radar target and the image target, it can be determined whether to continue the selection as the target object when the target object has transitioned to the state where the target object is detected only as the radar target. For example, in the state where the target object is detected as both of the radar target and the image target, a degree of agreement between the detection position of the radar target and the detection position of the image target is determined. On the condition that it is determined that the degree of agreement between the detection position of the radar target and the detection position of the image target is not less than a predetermined value, the selection as the target object can be continued when the target object has transitioned to the state where the target object is detected only as the radar target.

FIG. 2 shows an example where the detection range θ1 of the radar 21 is wider than the detection range θ2 of the image sensor 22 and the whole detection range θ2 of the image sensor 22 is included in the detection range θ1 of the radar 21. Besides this example, the above process is applicable to the case where the detection range θ1 of the radar 21 does not agree with the detection range θ2 of the image sensor 22 and part of detection range θ1 and part of the detection range θ2 are overlapped with each other. For example, in the case where the detection range θ1 of the radar 21 is narrower in the width direction than the detection range θ2 of the image sensor 22, in the flow chart shown in FIG. 3, it can be determined whether to continue the selection as the target object when the target object has transitioned to the state where the target object is detected only as the image target.

The aforementioned embodiment shows the example where an object is detected by using the radar 21 and the image sensor 22. Besides this example, the above process is applicable to the case where an object present around the own vehicle M is detected by using a plurality of detection sections having different detection ranges.

The aforementioned embodiment shows the example where the image processing section 12A is provided in the image target detection section 12. The configuration is not limited to this and the image processing section 12A can be provided also in the radar target detection section 11. That is, the image processing section 12A is only necessary to be provided in at least one of the radar target detection section 11 and the image target detection section 12.

The radar 21 of the present embodiment corresponds to a first target detection section. The image sensor 22 of the present embodiment corresponds to a second target detection section. In FIGS. 3 and 4, the processes in S14 and S21 constitute the selection section 13A as a function. In FIG. 3, the process in S15 constitutes the state determination section 13B as a function. The processes in S17 to S20 constitute the continuation determination section 13C as a function. The process in S16 constitutes the moving object determination section 14 as a function. The vehicle control ECU corresponds to a collision avoidance section. In FIG. 4, the process in S23 constitutes the collision avoidance section as a function.

The present disclosure is described with reference to the examples, but it will be understood that the present disclosure is not limited to the examples or configurations. The present disclosure encompasses various modified examples and variations within an equal range. In addition, a category or range of thought of the present disclosure encompasses various combinations or forms and other combinations or forms including only one element, one or more elements, or one or less elements of those.

### REFERENCE SIGNS LIST

10 . . . Object detection device
11 . . . Radar target detection section
12 . . . Image target detection section
13 . . . Object detection section
14 . . . Moving object determination section

1. An object detection device comprising:
a first target detection section for detecting, as a first target, an object included in a first detection range ahead of an own vehicle;
a second target detection section for detecting, as a second target, an object included in the first detection range and in a second detection range narrower in a vehicle width direction than the first detection range;
a selection section for selecting, as a target object to be subjected to collision avoidance control, the object on the condition that the first target and the second target are the same object, in a first state where a detection position of the object is inside the first detection range and inside the second detection range;
a state determination section for determining whether a detection position of the target object has transitioned from the first state to a second state where the detection position of the object is outside the second detection range and inside the first detection range;
a moving object determination section for determining whether the target object is a predetermined moving object; and
a continuation determination section for continuing selection as the target object on the condition that the target object is the predetermined moving object, when the detection position of the target object has transitioned to the second state.

2. The object detection device according to claim 1, wherein the moving object determination section determines that the target object is the predetermined moving object when the object is a two-wheeled vehicle.

3. The object detection device according to claim 1, wherein the continuation determination section continues the selection as the target object on the condition that a movement speed of the target object in a direction orthogonal to a direction of travel of the own vehicle is higher than a predetermined value and that the target object is moving closer to the own vehicle.

4. The object detection device according to claim 1, wherein the continuation determination section cancels the selection as the target object on the condition that the target object is moving away from the own vehicle in a direction orthogonal to a direction of travel of the own vehicle.

5. The object detection device according to claim 1, wherein the continuation determination section continues the selection as the target object on the condition that the target object is located ahead of the own vehicle and that a direction of travel of the target object is oriented to an own vehicle lane.

6. The object detection device according to claim 1, wherein
the continuation determination section continues the selection as the target object on the condition that time that has elapsed after the detection position of the object selected as the target object has transitioned to the second state is less than a predetermined value.

7. The object detection device according to claim 1, wherein:
at least one of the first target detection section and the second target detection section includes an image processing section for identifying a type of the object by performing image processing of a captured image of an area ahead of the own vehicle, and
the moving object determination section determines whether the target object is a moving object based on the image processing performed by the image processing section.

8. The object detection device according to claim 7, wherein the first target detection section includes a radar for detecting the first target by using a reflected wave of electromagnetic waves transmitted to the area ahead of the own vehicle, and the second target detection section includes the image processing section.

9. The object detection device according to claim 1, further comprising a collision avoidance section for determining to perform collision avoidance control when the selection as the target object is continued by the continuation determination section, and when the target object collides with the own vehicle with high probability.

10. An object detection method comprising:
a first target detecting step of detecting an object included in a first detection range ahead of an own vehicle;
a second target detecting step of detecting an object included in the first detection range and in a second detection range narrower in a vehicle width direction than the first detection range;
a selecting step of selecting, as a target object to be subjected to collision avoidance control, the object on the condition that the first target and the second target are the same object, in a first state where a detection position of the object is inside the first detection range and inside the second detection range;
a state determining step of determining whether a detection position of the target object has transitioned from the first state to a second state where the detection position of the object is outside the second detection range and inside the first detection range;
a moving object determining step of determining whether the target object is a predetermined moving object; and
a continuation determining step of continuing selection of as the target object on the condition that the target object is the predetermined moving object, when the detection position of the target object has transitioned to the second state.

11. The object detection method according to claim 10, wherein:
at least one of the first target detecting step of detecting and the second target detecting step of detecting includes an image processing step of identifying a type of the object by performing image processing of a captured image of an area ahead of the own vehicle; and
it is determined in the moving object determining step whether the target object is a moving object based on the image processing performed in the image processing step.

12. The object detection method according to claim 10, further comprising:
a collision avoiding step of determining to perform collision avoidance control when the selection as the target object is continued in the continuation determining step and the target object collides with the own vehicle with high probability.

13. The object detection device according to claim 2, wherein the continuation determination section continues the selection as the target object on the condition that a movement speed of the target object in a direction orthogonal to a direction of travel of the own vehicle is higher than a predetermined value and that the target object is moving closer to the own vehicle.

14. The object detection device according to claim 13, wherein the continuation determination section cancels the selection as the target object on the condition that the target object is moving away from the own vehicle in a direction orthogonal to a direction of travel of the own vehicle.

15. The object detection device according to claim 14, wherein the continuation determination section continues the selection as the target object on the condition that the target object is located ahead of the own vehicle and that a direction of travel of the target object is oriented to an own vehicle lane.

16. The object detection device according to claim 15, wherein
the continuation determination section continues the selection as the target object on the condition that time that has elapsed after the detection position of the object selected as the target object has transitioned to the second state is less than a predetermined value.

17. The object detection device according to claim 16, wherein:
at least one of the first target detection section and the second target detection section includes an image processing section for identifying a type of the object by performing image processing of a captured image of an area ahead of the own vehicle, and
the moving object determination section determines whether the target object is a moving object based on the image processing performed by the image processing section.

18. The object detection device according to claim 3, wherein the continuation determination section continues the selection as the target object on the condition that the target object is located ahead of the own vehicle and that a direction of travel of the target object is oriented to an own vehicle lane.

19. The object detection device according to claim 18, wherein
the continuation determination section continues the selection as the target object on the condition that time that has elapsed after the detection position of the object selected as the target object has transitioned to the second state is less than a predetermined value.

20. The object detection device according to claim 19, wherein:
at least one of the first target detection section and the second target detection section includes an image processing section for identifying a type of the object by performing image processing of a captured image of an area ahead of the own vehicle, and
the moving object determination section determines whether the target object is a moving object based on the image processing performed by the image processing section.
